(19) United States
(12) Patent Application Publication
(10) Pub. No.: US 2011/0268632 A1
(43) Pub. Date: Nov. 3, 2011

(54) HYDROMETALLURGICAL METHOD FOR THE REUSE OF SECONDARY ZINC OXIDES RICH IN FLUORIDE AND CHLORIDE

(75) Inventors: Jean-Luc Roth, Thionville (FR); Valérie Weigel, Chevreuse (FR); Ludivine Piezanowski, Villerupt (FR); Stéphanie Michel, Freistroff (FR)

(73) Assignee: PAUL WURTH S.A., Luxembourg (LU)

(21) Appl. No.: 13/141,237

(22) PCT Filed: Dec. 22, 2009
(86) PCT No.: PCT/EP09/67767

§ 371 Date: Jul. 19, 2011

(30) Foreign Application Priority Data
Dec. 22, 2008 (LU) 91 509

(51) Int. Cl. C01G 9/02; C25C 1/16

(52) U.S. Cl. 423/103; 205/607

(57) ABSTRACT

The present invention relates to a method for removing halides, in particular chlorides and fluorides, from starting secondary zinc oxides, for example Waelz or Primus oxides, comprising the steps (1) for washing the secondary zinc oxides with sodium carbonate and separating the solid residue from the basic liquid, (2) leaching at least one portion of the solid residue of step 1 by means of H₂SO₄, preferably up to a pH between 2.5 and 4, and separating the solid residue from the acid liquid, and (3) treating the liquid from step 2 by adding Al³⁺ and PO₄³⁻ ions and a neutralizing agent in order to remove the residual fluoride, preferably at a pH<4, and separating the liquid from the solid residue containing fluorides.

### TECHNICAL FIELD

The present invention relates to a method for dehalogenation of secondary zinc oxides having strong chloride and fluoride contents mainly allowing recovery of the valuable contained zinc and which may be applied alone or as a supplement to a hydrometallurgical processing line of zinc concentrate.

### BACKGROUND

The industrial sector of steelworks and metallurgy is at the origin of the production of co-products rich in recoverable metals (Zn, Fe, Pb). Zinc-rich co-products, for example dusts from electric steelworks, are already recovered to a large extent, notably in the Waelz, PRIMUS processes.

Metal zinc is generally produced from the ore which undergoes different processing steps:
roasting
neutral leaching and acid leaching in a sulphuric acid medium
iron precipitation
purification
electrolysis.

Unfortunately this method for producing zinc only allows consumption of a small amount (<20%) of secondary zinc oxides from the concentration of dusts from electric steelworks. This percentage of secondaries cannot be larger because of strong fluoride (from 0.1% to 0.4%) and chloride (from 4 to 12%) contents which are real poisons both at roasting and during the electrolysis step (notably as regards the quality of the cathodic deposition, of the Faraday yield and corrosion phenomena of the electrodes and of their support).

These secondary oxides also contain strong zinc contents of the order of 40%-70% and consequently there is an obvious (both economical and ecological) challenge for recycling them.

Table 1 hereinbelow shows a typical analysis of the secondary oxides used:

TABLE 1

| Elements | Mass % |
|---|---|
| Zn | 40-70% |
| Fe | 0.5-8% |
| Pb | 3.5-8% |
| Cl | 4-12% |
| F | 0.1-0.4% |
| Al | 0.1-0.5% |
| Mn | 0.3-1% |
| Ni | 0.1-0.5% |
| Na | 1-3% |
| K | 2-4% |
| Cr | 0.1-0.5% |
| Ca | 1-2% |

The literature mentions hydrometallurgical patents for dehalogenation, mainly focused on washing. For example, patent EP 0773301 deals with the step for washing zinc oxide in a basic medium with sodium carbonate (60-140 kg/ton of oxide) at a temperature comprised between 50 and 90° C. After separation by filtration, the solid is washed and the liquid undergoes a step for precipitating fluorides as CaF₂ (addition of Na₂S or Ca(OH)₂3Ca₃(PO₄)₂). The study is conducted starting from a liquid/solid ratio of 5.

An analysis of the Waelz oxide used as well as its change during the washings is shown in the Table 2 hereinbelow.

TABLE 2

| | | Oxide after washing with | |
|---|---|---|---|
| | | Na₂CO₃ at | Oxide after washing |
| | Waelz oxide | 70° C. (80 g/kg of | with H₂O at 70° C. |
| Elements | (mass %) | oxide) (mass %) | (mass %) |
| Zn | 54.2 | 57.6 | 57.6 |
| Pb | 8.10 | 8.61 | 8.61 |
| Cd | 0.16 | 0.16 | 0.16 |
| Na | 0.61 | 0.33 | 0.10 |
| K | 1.67 | 0.24 | 0.08 |
| Cl | 4.25 | 0.35 | 0.05 |
| F | 0.25 | 0.12 | 0.10 |
| S | 1.10 | 0.17 | 0.07 |
| Total C | 1.44 | 2.22 | 2.22 |

Analysis of the solid shows that by washing with sodium carbonate under the conditions shown in the Table, about 92% of the chlorides and 52% of the fluorides may be removed. Washing with water as for it mainly allows the removal of the chlorides and of a small fraction of the fluorides.

In all cases, we see that there further remains 0.1% by mass of fluorides and 0.05% by mass of chlorides in the solid.

TABLE 3

| | | Na₂CO₃ washing (80 g/kg | H₂O washing at |
|---|---|---|---|
| Elements | mg/L | of oxide) at 70° C. | 70° C. |
| Zn | <0.05 | 0.5 mg/L | <0.1 mg/L |
| Pb | <0.01 | <0.1 mg/L | <0.1 mg/L |
| Cd | <0.05 | 0.94 mg/L | <0.05 mg/L |
| Na | 40 | 7,200 mg/L | 400 mg/L |
| K | 4 | 2,800 mg/L | 350 mg/L |
| Cl | 28 | 8,100 mg/L | 700 mg/L |
| F | 0.75 | 280 mg/L | 50 mg/L |
| S | 14 | 1,800 mg/L | 250 mg/L |

By analyzing the filtrates, it may be seen that strong sodium, potassium, chloride concentrations as well as concentrations of the order of 0.5 mg/L for zinc and 0.9 mg/L for cadmium are present in the filtrate from the sodium carbonate washing.

The method described in patent EP 0834583 (Ruhr-Zink) demonstrates the possibility of removing the halides by performing two basic washing steps with sodium carbonate (25-50 kg/ton of oxide), the first step of which is performed at a temperature of 90° C., whereas the second step is carried out in an autoclave under high pressure and at a temperature comprised between 110° C. and 130° C.

The result shown for this method (Table 4) demonstrates that two successive washings with sodium carbonate allow removal of a significant portion of the chlorides and fluorides.

TABLE 4

| | Waelz oxide | Oxide (mass %) after two Na₂CO₃ washings |
|---|---|---|
| Elements | (mass %) | (25-50 g/kg of oxide), at 90° C. and 120° C. |
| Zn | 64 | |
| Pb | 7 | |
| Fe | 0.5 | |
| Na | 1.5 | |
| K | 2.9 | |
| Cl | 5 | 0.01 |
| F | 0.2 | 0.03 |

However, in spite of the two successive washings with sodium carbonate, the final fluoride content is 0.03% and that for the chlorides is 0.01%.

Finally, a method based on removal of fluorides in a solution of zinc, nickel, cadmium, manganese and/or magnesium sulphates is described in patent application EP 0132014 A2. The two steps of this method are:
addition of Al³⁺ and PO₄³⁻ ions to the solution so that it contains at least 1 g/L of Al³⁺ and 3.5 g/L of PO₄³⁻ at a temperature comprised between 45° C. and 90° C.; the amount of PO₄³⁻ is added as a stoichiometric amount relatively to that of Al³⁺,
neutralization of the solution at a pH greater than 4 and less than 5.5 with calcium carbonate.

The different examples shown in this patent show that in all cases, it is possible to obtain fluoride concentrations of less than 50 mg/L by performing both steps: addition of aluminium in an amount from 2 g/L to 3 g/L and of phosphates in a stoichiometric amount and neutralization. It was also shown that by increasing the temperature from 50° C. to 90° C. it was possible to improve filterability of the solid, but not the final fluoride concentration.

If the starting solution is acid, a neutralization step will precede the step for adding Al³⁺ and PO₄³⁻ ions.

Finally, the last example mentioned in patent application EP 0132014 A2 shows the possibility of reducing the fluoride concentration (500 mg/L) in a solution of zinc sulphate at pH=4.5 by using in a first step both a solution of concentrated sulphuric acid and the precipitate obtained after a neutralization step with addition of 3 g/L of aluminium per litre of zinc solution followed by a second neutralization step with calcium carbonate at 50° C. The obtained solution has a concentration of less than 30 mg/L of fluorides.

In all the examples of this patent, a significant use of aluminium which is an expensive reagent, is reported.

Brief Summary

The invention provides a method with which from a feed including more than 20% of secondary oxides, a purified zinc solution may be obtained, having a fluoride concentration less than 50 mg/L, preferably less than 30 mg/L.

In order to solve the aforementioned problem, the present invention proposes a method for removing halides, in particular chlorides and fluorides, starting with secondary zinc oxides, for example Waelz or Primus oxides, the method comprising the steps of
(1) washing secondary zinc oxides with sodium carbonate and separating the solid residue R1 from the basic liquid L1,
(2) acid leaching of at least a portion of the solid residue R1 from step 1 by means of H₂SO₄, preferably up to a pH between 2.5 and 4, and separating the solid residue R2 (containing some heavy metals such as lead, iron, silver) from the acid liquid L2, this R2 residue may advantageously be recovered in the lead industry which carries out separation with silver, and
(3) treating the liquid L2 from step 3 by adding Al³⁺ ions and PO₄³⁻ ions and a neutralizing agent in order to remove the residual fluoride, preferably at a pH<4, and separating the liquid L3 from the solid residue R3 containing the fluorides and certain heavy metals such as iron and lead.

With the method according to the invention, it is possible to significantly reduce halide contents, i.e. that of chlorides and that of fluorides, in secondary oxides initially containing significant amounts of these halides, for example but not exclusively, Waelz or Primus oxides. By removing the major portion of the initially present halides and at the same time certain undesirable metals such as lead and iron, these secondary oxides may be used and recovered in methods which were unusable hitherto because of their sensitivity to halides, in particular electrolysis.

Further, it is seen that the residual halide contents are significantly less than those obtained with known methods. Moreover, the performances of the method according to the invention are further obtained by minimizing the operational costs, notably by avoiding too high temperatures (<100° C.), therefore preferably under atmospheric pressure, and by minimizing the consumption of expensive reagents, i.e. aluminium. The method according to the invention therefore does not require particular installations and may be applied in a relatively economical way.

Therefore, the method proposed in the present invention allows the fluoride content to be reduced to a value less than 0.02% and the chloride content to less than 0.01% and thus zinc may be recovered from iron metallurgical dusts, as well as other metals (lead, iron, etc. . . . ) in a process which may be fed with up to 100% of these residues, “secondary sources” of zinc.

The washing of step 1 is an important step of the method according to the invention considering that it allows removal of the major portion of the halides. The washing of secondary zinc oxides with sodium carbonate of step 1 may further be improved if it is performed in at least two successive substeps and preferably with counterflow, the first being carried out at a temperature less than 80° C., for example comprised between 55° C. and 65° C., preferably at about 60° C., and the last substep of these at least two substeps at temperatures less than 100° C., for example between 90° C. and 100° C., preferably at about 95° C. At least the last substep further comprises a solid-liquid separation.

In a further preferred alternative, this washing of step 1 is carried in three substeps (three washings possibly each followed by a liquid-solid separation) and that with the sodium carbonate introduced (at least partially) at the third substep (third washing) is conducted with counterflow relatively to the secondary zinc oxides. During the first washing, the temperature of the solution is less than 80° C. with an optimum at 60° C. After decantation and separation, the solid undergoes a second washing at a temperature less than 100° C., preferably 95° C. After fresh decantation and separation, the solid is subject to a third washing under the same conditions as during the second washing. As mentioned earlier, the washings are accomplished in all cases under atmospheric pressure and therefore do not require any particular installation, such as an autoclave.

The sodium carbonate used in step 1 is selected from sodium carbonate, sodium sesquicarbonate, sodium bicarbonate, as well as their hydrates. The amount of sodium carbonate may vary from 80 g/kg of oxide to 240 g/kg of oxide, and preferably from 160 g/kg of oxide. The pH measured at 20° C. during washing(s) is generally greater than 8.

In step 2, the residue R1 is treated in the presence of sulphuric acid so as to place in solution the major portion of zinc and to precipitate it, notably to recover a portion of lead, iron respectively, and if necessary, the silver present.

The temperature during step 2 is preferably located between 50 and <100° C. and the pH is adjusted between 2.5 and 4, preferably between 2.7 and 3.8, and in particular between 3.0 and 3.5.

In an advantageous embodiment, step 2 is carried out in two or more consecutive reactors, so as to be able to refine the pH in the last reactor to the values indicated above. Thus, in the case of a three reactor cascade, it is preferable to start from a very low pH (pH about 1) and gradually increase it in the following reactors, so as to obtain in the third reactor a pH of about 3. The pH is adjusted in a preferred way with the solid R1.

The solid residue R2 from step 2 is then separated from the liquid fraction L2 which is transferred to step 3. The goal of step 3 is to further reduce the fluoride content, already reduced by a large amount in step 1. As the goal is to reach fluoride concentrations of less than 50 mg/L, preferably less than 30 mg/L, this goal is achieved by adding aluminium ions in an amount less than 1 g/L preferably of the order of 0.5 g/L and phosphate ions in a stoichiometric amount and then by neutralization with an appropriate base. Defluorination is significantly improved when the pH is less than about 4. Consequently, in a preferred embodiment of the method, the pH of step 3 is adjusted between 2.5 and 4, preferably between 3.2 and 4, and in particular between 3.4 and 3.8.

This partial neutralization may be achieved by adding a conventional base such as for example sodium hydroxide, calcium hydroxide, lime, etc.

Nevertheless, in an advantageous alternative of the method, the neutralizing agent of step 3 is entirely or partly replaced with a solid residue R1 from step 1. Indeed, the inventors have found that it was possible to introduce a part of the basic residue R1 from step 1 for the purpose of neutralization, in a proportion less than 10 wt.-%, preferably between 1 and 5% of the amount of R1, and to be able to thereby reduce or even totally avoid the use of expensive conventional neutralizing agents during step 3. This alternative therefore allows further minimization of the operating costs.

In certain cases when the iron content is significant, it would be advantageous to be able to complete the precipitation of iron at the end of step 3. In this case, a suitable embodiment comprises slightly increasing the pH at the end of step 3 by partial neutralization at pH values between 5 and 5.5, preferably 5.2, preferably by an extra addition of solid R1 from step 1.

As for the temperature, it was seen that suitable temperatures of values are located between 40° and 80° C., preferably between 50° C. and 75° C.

An additional aspect of the invention provides, in addition to partial removal of halides, iron and lead, also removal of other elements such as copper, cadmium, cobalt and nickel.

Consequently, in an additional advantageous alternative of the above method, the latter further comprises a step 4 for purifying the liquid L3 from step 3 by reduction of less reducing metals than zinc, in particular copper, cobalt, nickel and cadmium, by adding a suitable reducing agent, preferably zinc powder, followed by separation of the solid residue R4 from the purified liquid L4 containing zinc ions.

This step 4 is a step for purifying the solution which may be contemplated when the solution L3 from step 3 contains certain impurities. Indeed, after step 3, in addition to the Zn²⁺ ions, there generally remains undesirable ions, such as Cu²⁺, Cd²⁺, N²⁺, Co²⁺ and Mn²⁺. Removal of most of these undesirable ions is carried out by reduction by means of a suitable reducing agent having a more significant reducing power. As on the other hand, it is not desirable to reduce the zinc ions, it is particularly advantageous to use (metal) zinc powder, preferably a fine powder, especially as with the use of zinc powder it is possible to avoid the introduction of extraneous ions and this is therefore preferred. The possibly present Mn²⁺ ions will not be reduced and will remain in solution, but on the other hand the other ions will be reduced according to the reaction

Zn+M²⁺→Zn²⁺+M

The purification operation may be accomplished in a single step, but it may be necessary or desirable to proceed with several successive purifications before carrying out the solid-liquid separation. Indeed, the difficulty of extracting the elements follows the following order with increasing difficulty: copper, cadmium, nickel, cobalt. If necessary, the temperature may in particular be adapted by adjusting it for example between 45° C. and 65° C. for cadmium, and between 70° C. and 95° C. for cobalt. The resulting liquid L4 (a solution comprising Zn²⁺ ions) and the solid R4 are then separated by suitable means, for example by filtration. It is also possible to proceed in a single step while using an intermediate temperature of the order of 75° C.

Still an additional aspect of the invention relates to recovery of zinc as metal zinc, preferably with a high level of purity. Consequently, an advantageous embodiment of the invention further provides a step 5 for electrolysis of at least one portion of the zinc in solution in the liquid from the preceding step, i.e. step 3 (L3) or if necessary step 4 (L4) in order to obtain metal zinc and a zinc-depleted liquid.

Thus, the solution L3 containing Zn²⁺ ions, if necessary certain of its impurities having been removed in step 4, L4, is sent to electrolysis (step 5). The zinc deposited on the cathode is very pure, i.e. with at least a so-called HG (High Grade, >99.98%) quality, preferably a so-called SHG (Special High Grade, >99.99%) quality.

The used electrolysis solution L5 obtained after step 5 however always contains a non-negligible amount of zinc ions. In an advantageous alternative of the method, this zinc-depleted liquid from step 5 is at least in part recycled to step 2. Indeed, the liquid L5 flowing out of the electrolysis also contains some acidity, especially in the form of sulphuric acid, and therefore not only allows optimization of recovery of zinc by recycling, but may also advantageously complete the acidification carried out in step 2.

Nevertheless, even if such recycling of the used electrolysis solution is step 2 is desirable, it inevitably causes the risk of certain chemical species (essentially sodium, potassium and magnesium) of building up and compromising the course of the reactions at different subsequent steps if no suitable action is provided.

Consequently, complementarily or even alternatively to the above recycling (of a portion) of the used electrolysis solution in step 2, a purge of salts may be carried out by adding a neutralizing agent, for example a conventional base, right up to a pH comprised between 6 and 7 allowing precipitation of zinc up to a residual content less than 1 g/L. Zinc precipitation is followed by extraction of the thereby precipitated zinc from the liquid containing the salts, and this precipitated zinc is then recycled in step 2. This step is preferably carried out between 40° C. and 80° C., in particular at a temperature close to 60° C.

Indeed, this way of proceeding allows removal of certain elements in solution in the liquid obtained after separation, which, without such a treatment, would not be able to be removed effectively, notably sodium, potassium, magnesium, but also manganese which cannot be removed by the step 4 of purification by reduction. With this step, it is therefore possible at the most to purify the zinc and to keep the other ions in solution.

Further, as mentioned above, chlorides and to a lesser extent fluorides are almost entirely removed in step 1. Nevertheless, unlike the fluorides for which removal is completed in step 3, steps 2 and 3, possibly 4 and 5, do not significatively reduce the chloride content and the constant introduction of a residual or even very small amount of chlorides at the end of step 1 in a looped process therefore risks causing an undesirable build-up of chlorides. As with step 6, it is precisely possible to also remove chlorides in the separated liquid after precipitation of zinc, this step effectively prevents not only build-up of the aforementioned metals but also that of chlorides.

Finally, a significant advantage of this step is therefore that it not only prevents the loss of the zinc contained in the liquid L5, when the too large salt contents would otherwise force it to be entirely discarded from the process, but it further allows working under more constant and better controlled conditions.

In a preferred alternative of the method, at least one portion of the solid residue R1 from step 1 is introduced to step 6 as a total or partial replacement for the conventional neutralizing agent. The R1 fraction introduced in step 6, therefore allows the solution to be neutralized at a lesser cost right up to the indicated pH, and therefore zinc to be precipitated up to a residual content less than 1 g/L. This required R1 fraction generally represents between 10 and 60%, preferably between 20 and 55%, more preferably between 45 and 50% by mass of R1, the remaining fraction being directly introduced into step 2 and possibly into step 3. Consequently, an additional advantage of the alternative using the A1 solid is that resorting to expensive reagents is not required.

Solid-liquid separations carried out during the different steps may be achieved by any known suitable means, for example by decantation, filtration, centrifugation, etc.

Finally, the main advantage of the alternatives of the methods as shown above, is that they may be integrated in an operating plant based on a standard process comprising the roasting, leaching, purification and electrolysis steps (illustrated in FIG. 2) and in that secondary zinc oxides which up to now were difficult to use may thereby be recovered economically.

### BRIEF DESCRIPTION OF THE DRAWINGS

Other particularities and features of the invention will become apparent from the detailed description of an advantageous embodiment presented below, as an illustration, with reference to the appended drawing. The latter shows:

FIG. 1: a block diagram of a preferred embodiment of the invention.

FIG. 2: a diagram for integrating the method in an operating plant based on a standard process.

### DETAILED DESCRIPTION

The secondary oxides which may be used in a method according to the invention, of course have variable contents of different elements, if necessary present under various forms.

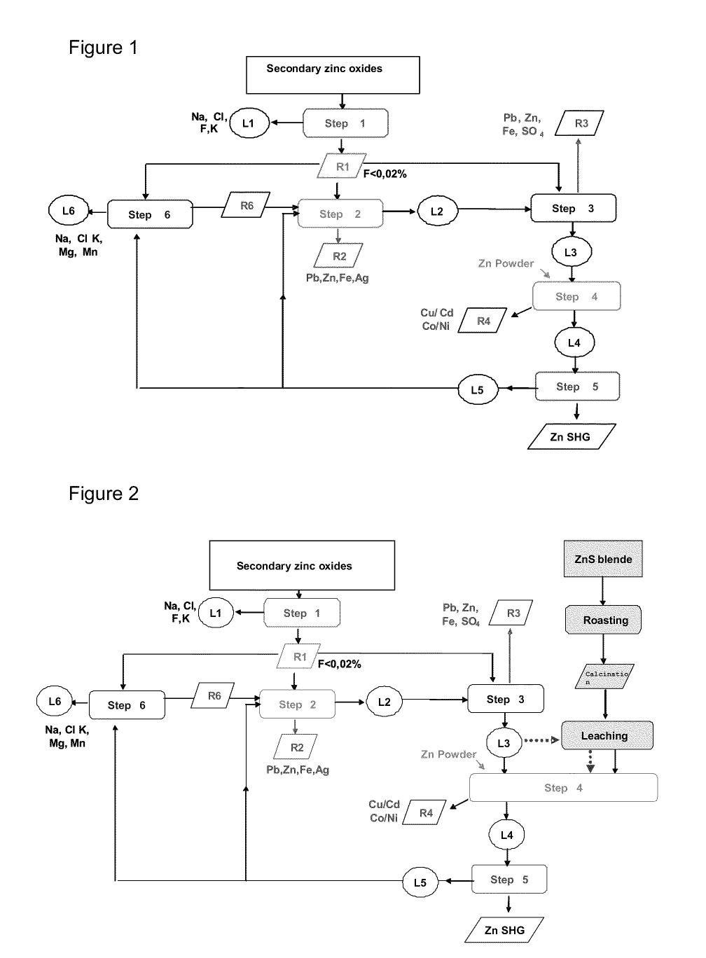

In the example described below with reference to FIG. 1, these starting secondary oxides have the following composition:

Zn˜54.8%, Fe˜3.6%, Pb˜6.7%, Cl˜7.2%, F˜0.3%, Cu˜0.14%, Cd˜0.16%, Ni˜0.006%, Co˜0.001%, Mg˜0.2%, Na˜2.8%, K˜2.5%, Mn˜0.45%, Ag˜0.016% (mass %).

As a rule, removal of halides, in particular of chlorides and fluorides, present in the dusts, is carried in two big steps: step 1 and step 3.

The first step (step 1) of a preferred embodiment of the method is a washing step wherein the solid undergoes three successive washings with sodium carbonate (160 g of Na₂CO₃/kg of oxide) at well-defined temperatures for each washing. During the first washing, the temperature of the solution is about 60° C. After decantation and separation, the solid undergoes a second washing at about 95° C. After decantation and separation, the solid undergoes a third washing under the same conditions as in the second washing. After decantation and filtration, the solid is washed with water for a last time. At the end of this step, the solid R1 no longer contains any chlorides (for example<0.004% by mass) but further contains a small amount of fluorides less than 0.02% by mass. The liquid L1 obtained during this step contains in majority potassium and sodium chlorides, fluorides.

In the example above, the L1 contents were the following:

Zn˜0.1 g/L, Na˜40 g/L; K˜10 g/L, Pb˜0.3 g/L, Cl˜28 g/L, F˜1.4 g/L.

The solid R1 then undergoes in step 2, acid leaching with sulphuric acid. The R2 residue obtained mainly contains iron, lead and silver. The experimental values are the following: 30% Pb, 15% Fe, 7% Zn, 0.07% Ag.

The liquid L2, preferably completed with a portion of the residue R1 (in the example: 3%) is recovered for passing to a so-called de-fluorination step 3. This step as a rule comprises a step for adding a precipitating agent in well-defined proportions (Al³⁺ and PO₄³⁻) and of a neutralization step. The proportions of the precipitating agents are 0.5 g/L for aluminium and in a stoichiometric amount for phosphates. The temperature during this step is 70° C.

Phosphates are added in a 1:1 molar proportion with aluminium.

The residue R3 of the de-fluorination step is removed from the process and had the following contents: 11.8% Pb, 10.8% Fe, 6.5% Zn, 1.1% F. These residues may be advantageously recycled in known processes such as the Waelz, Primus processes, etc.

Step 4 is a purification step by reduction of the zinc powder with which the liquid L3 may be stripped of its copper, cadmium, cobalt, and nickel contents and they may be recovered in the solid R4. The experimental composition was the following: 20% Cu, 32% Cd, 0.9% Ni. The absence of cobalt is explained in this case by the very low initial cobalt content in the secondary oxides used. As indicated earlier, the manganese is not reduced during this step and remains in the purified liquid L3 (L4).

The elementary analysis of the liquid L4 was the following:

Zn˜147 g/L, Cl˜0.3 g/L, F<30 mg/L, Cu˜0.1 mg/L, Co˜0.2 mg/L, Mg˜3.5 g/L, Na˜8 g/L, K˜6 g/L, Mn˜7 g/L.

The step for recovering valuable zinc is the step 5 of this method and it is performed by means of an electrolysis, for example such as described in “Techniques de l'ingénieur” (zinc metallurgy (M2 270), paragraph 7.5 electrolysis), allowing to reduce in a targeted manner the Zn²⁺ ions in metal zinc. The metal zinc is deposited on the cathode and is very pure (SHG quality, >99.99%).

The electrolysis solution used L5 contained in the example above: Zn˜55 g/L, Mg˜3.5 g/L, Na˜8.5 g/L, K˜6.1 g/L, Mn˜7.5 g/L, Cl˜0.37 g/L, F˜0.014 g/L, H₂SO₄˜180 g/L.

A portion of about 90%, of L5, is then directly recycled in step 2. The remainder of L5 is first preferably subject to a step 6 of desalting (purge of the salts) by precipitation of the zinc. The solid residue R6 containing the zinc is then re-introduced to step 2, while the liquid L6 carries off a large portion of the elements not removed by the preceding steps, but also chlorides and to a lesser extent fluorides. The experimental L6 contents were the following: Zn˜0.8 g/L, Mg˜2.6 g/L, Na˜5.65 g/L, K˜2.7 g/L, Mn˜5.1 g/L, Cl˜0.211 g/L, F˜0.005 g/L.

1. A method for removing halides starting from secondary zinc oxides, comprising the steps of
(1) washing secondary zinc oxides with sodium carbonate and separating solid residue from a basic liquid,
(2) leaching at least a portion of the solid residue from step 1 by means of H₂SO₄, and separating the solid residue from an acid liquid, and
(3) treating the liquid from step 2 by adding Al³⁺ ions and PO₄³⁺ ions and a neutralizing agent in order to remove residual fluoride, wherein the neutralizing agent comprises solid residue of step 1, and separating the liquid from the solid residue containing the fluorides.

2. The method according to claim 1, wherein the washing of secondary zinc oxides with sodium carbonate in step 1 is achieved in at least two substeps of successive washings, a first being carried out at a temperature less than 80° C. and a last of the at least two substeps at temperatures less than 100° C., at least the last of the at least two sub-steps further comprising a solid-liquid separation.

3. The method according to claim 2, wherein the washing in step 1 is carried out in three substeps and the sodium carbonate introduced at a third substep is conducted in counterflow relatively with the secondary zinc oxides.

4. The method according to claim 1, wherein the neutralizing agent of step 3 comprises solid residue of step 1 in a proportion of less than 10% of the amount of the residue of step 1.

5. The method according to claim 1, wherein pH at the end of step 3 is increased to a value between 5 and 5.5 in order to complete precipitation of iron.

6. The method according to claim 1, further comprising, the step of
(4) purification of the liquid from step 3 by reduction of metals less reducing than zinc, by adding of a reducing agent and separating the solid residue from the purified liquid.

7. The method according to claim 6, further comprising, the step of
(5) electrolysis of at least one portion of the zinc in solution in the liquid of the preceding step in order to obtain metal zinc and a zinc-depleted liquid.

8. The method according to claim 7, wherein at least one portion of the zinc-depleted liquid from step 5 is at least in part recycled in step 2.

9. The method according to claim 7, further comprising the step of
(6) purging salts and precipitating the zinc from the zinc-depleted liquid of step 5 by adding a neutralizing agent and recycling of the precipitated zinc into step 2.

10. The method according to claim 9, wherein the neutralizing agent of step 6 comprises solid residue from step 1.

11. The method according to claim 1, wherein the secondary zinc oxides are Waelz or Primus oxides.

12. The method according to claim 1, wherein the step 2 comprises leaching at least a portion of the solid residue from step 1 by means of H₂SO₄ up to a pH between 2.5 and 4, and separating the solid residue from the acid liquid.

13. The method according to claim 1, wherein the step 3 comprises treating the liquid from step 2 by adding Al³⁺ ions and PO₄³⁻ ions and a neutralizing agent in order to remove the residual fluoride at a pH<4, wherein the neutralizing agent comprises solid residue of step 1, and separating the liquid from the solid residue containing the fluorides,

14. The method according to claim 2, wherein the first substep is carried out at a temperature of about 60° C.

15. The method according to claim 2, wherein the last substep of the at least two substeps is carried out at a temperature of about 95° C.

16. The method according to claim 1, wherein pH at the end of step 3 is increased to a value between 5 and 5.5 by adding solid residue from step 1.

17. The method according to claim 6, wherein the metals less reducing than zinc is copper, cobalt, nickel, cadmium.

18. The method according to claim 6, wherein the reducing agent is zinc powder.
